(19) United States
(12) Patent Application Publication
(10) Pub. No.: US 2002/0101412 A1
(43) Pub. Date: Aug. 1, 2002

(54) Pointing device

(76) Inventor: Katsu Tasaki, Fukuoka (JP)

Correspondence Address: Ratner & Prestia, Suite 301, One Westlakes, Berwyn, P.O. Box 980, Valley Forge, PA, 19482-0980, US

(21) Appl. No.: 10/041,049

(22) Filed: Jan. 7, 2002

(30) Foreign Application Priority Data
Jan. 5, 2001 (JP) 2001-000312

(51) Int. Cl. G09G 5/00

(52) U.S. Cl. 345/179

(57) ABSTRACT

An indicator includes an ultrasonic wave oscillator for transmitting an ultrasonic signal at its tip. Three ultrasonic wave receivers disposed on a board receive the ultrasonic wave transmitted from the indicator. Moving distances in two directions of a pointer on the board pointed with the indicator are calculated based on a varying amount of the signal received by each receiver. A projector projects the pointer onto the board.

### FIELD OF THE INVENTION

The present invention relates to a pointing device used for operating a pointer displayed on a board.

### BACKGROUND OF THE INVENTION

A digitizer capturing coordinates by pointing at a design drawing attached on a board with a dedicated pen and thus for inputting the design drawing into a personal computer (PC) is used widely.

FIG. 8 is a schematic block diagram of a board employing a conventional digitizer. A front projector 103 projects an image processed by a PC 102 onto a board 101 shown in FIG. 8. A dedicated pen 104 has a function of emitting infrared radiation and ultrasonic wave. The pen 104 emits infrared radiation and ultrasonic wave to sensors 105 disposed at both upper ends of the board 101, and has a position measured by trigonometry.

The position of the pen 104 on the board 101 displaying an image from the PC 102 is measured and fed into the PC 102, and a pointer for indicating the position can be displayed on the board 101. The pointer in the displayed image can be operated in accordance with a motion of the pen 104 similarly to a pointing device such as a mouse.

When tracing on the board 101 with the dedicated pen 104, a user is located in a projecting area of the front projector 103. Therefore, shadows of the pen 104 and the user then fall on the board 101, so that the image on the board 101 is hardly watched. When a wide image is displayed on a large board 101, a user must move for pointing at a desired position, thereby lowering the operability.

### SUMMARY OF THE INVENTION

A pointing device operates a pointer displayed on a board from a remote place.

The pointing device includes an indicator including a first transmitter for transmitting a first signal, a board including at least three receivers for receiving the first signal, and an operating unit for calculating moving amounts in two directions of a pointer on the board pointed with the indicator based on a variation of the first signal received by each receiver.

In the pointing device, three receivers disposed on the board detect an operation of the indicator, and the pointer moves in proportion to the moving speed of the indicator.

### BRIEF DESCRIPTION OF THE DRAWINGS

FIG. 1 is a schematic block diagram of a board having a pointing device in accordance with exemplary embodiment 1 of the present invention.

FIG. 2 is a block diagram of a signal processing in the board shown in FIG. 1.

FIG. 3 illustrates an operation in which an indicator points at a pointer from a position P1 to a position P2 on the board.

FIG. 4 shows outputs from peak detectors and outputs from differential detectors in the operation shown in FIG. 3.

FIG. 5 is a perspective view of an indicator of a pointing device in accordance with exemplary embodiment 2 of the present invention.

FIG. 6 is a block diagram of a signal processing in a board using the indicator shown in FIG. 5.

FIG. 7 shows respective outputs from an amplifier/bandpass filter, a comparator, and a decoder of an auxiliary signal received by an auxiliary-signal receiver.

FIG. 8 is a schematic block diagram of a board employing a conventional digitizer.

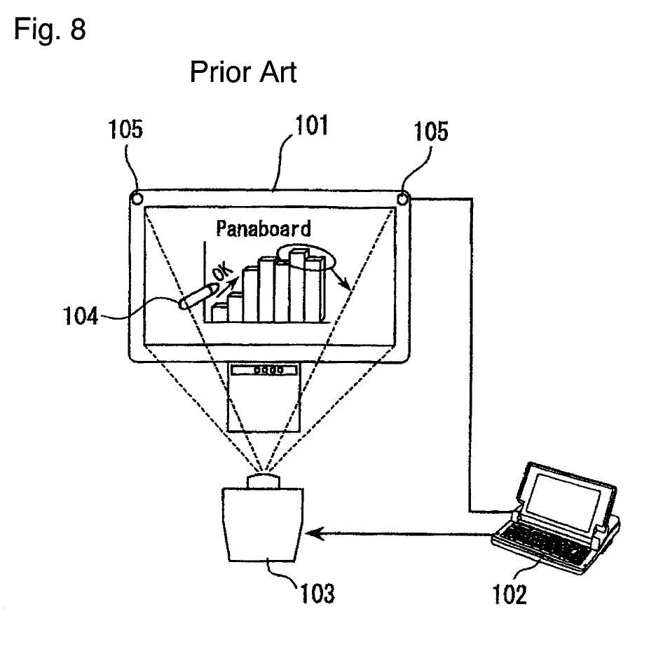

### DESCRIPTION OF THE PREFERRED EMBODIMENTS

(Exemplary Embodiment 1)

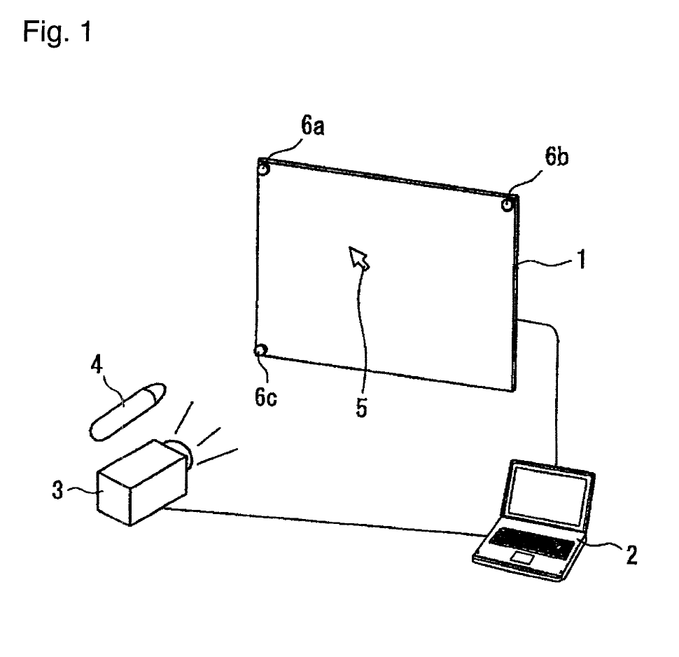

FIG. 1 is a schematic block diagram of a board having a pointing device in accordance with the exemplary embodiment 1 of the present invention. The board includes a board 1 as a screen used for displaying an image, a personal computer (PC) 2 for generating the image displayed on the board 1, a front projector 3 for projecting the image generated by the PC 2 onto the board 1, and an indicator 4 for operating a pointer 5 displayed by the PC 2 on the board 1.

The indicator 4 has an ultrasonic wave oscillator for transmitting an ultrasonic signal at its tip. Ultrasonic wave receivers 6a, 6b, 6c receive the ultrasonic signal transmitted from the indicator 4. The receivers 6a, 6b are disposed at respective upper ends of the board 1, and the receiver 6c is disposed at the left lower end of the board 1. In other words, the receivers 6a, 6b are arranged horizontally (in an X-direction), and the receivers 6a, 6c are arranged vertically (in a Y-direction).

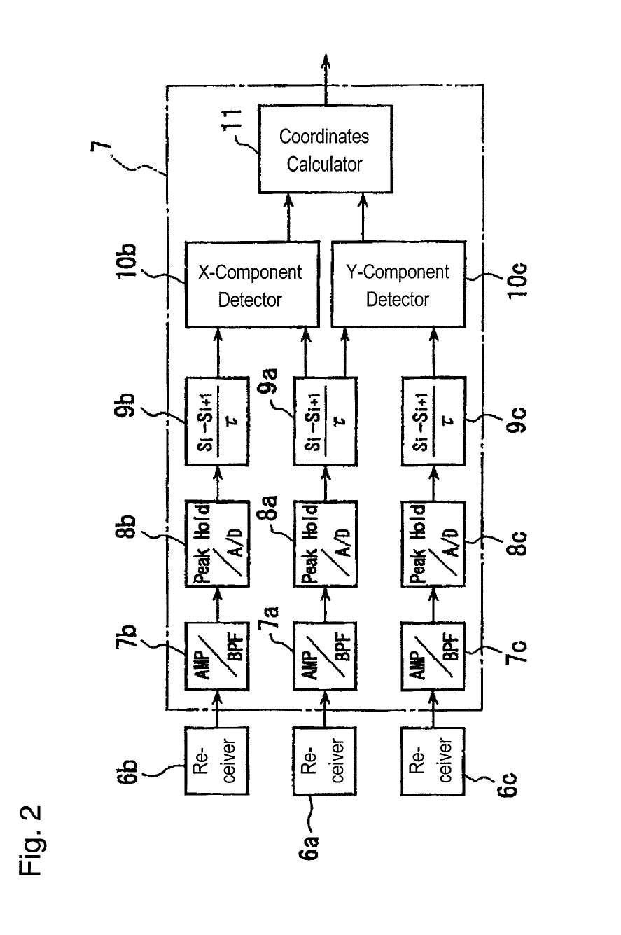

FIG. 2 is a block diagram of a signal processing in the board shown in FIG. 1. The board in accordance with the exemplary embodiment 1 includes an operating unit 7 for performing the signal processing shown in FIG. 2.

The operating unit 7 includes amplifier/band-pass filters (AMP/BFFs) 7a, 7b, 7c for receiving respective ultrasonic signals from the receivers 6a, 6b, 6c, peak detectors 8a, 8b, 8c for detecting peak values of the ultrasonic signals supplied from the AMP/BPFs 7a, 7b, 7c, difference detectors 9a, 9b, 9c for calculating respective differences per unit time of the peak values detected by the peak detectors 8a, 8b, 8c, an X-component detector 10b for detecting an X-directional component of a difference calculated by the detectors 9a, 9b, a Y-component detector 10c for detecting a Y-directional component of a difference calculated by the detectors 9b, 9c, and a coordinate calculator 11 for calculating coordinates representing the pointer 5 based on the X-directional and Y-directional components detected by the X-component detector 10b and the Y-component detector 10c.

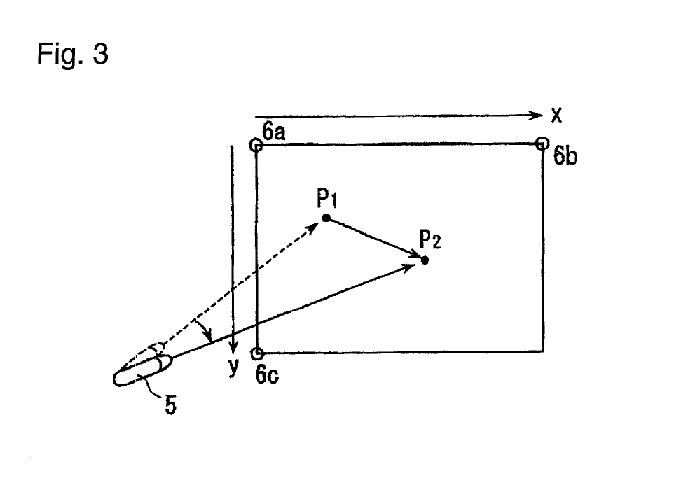

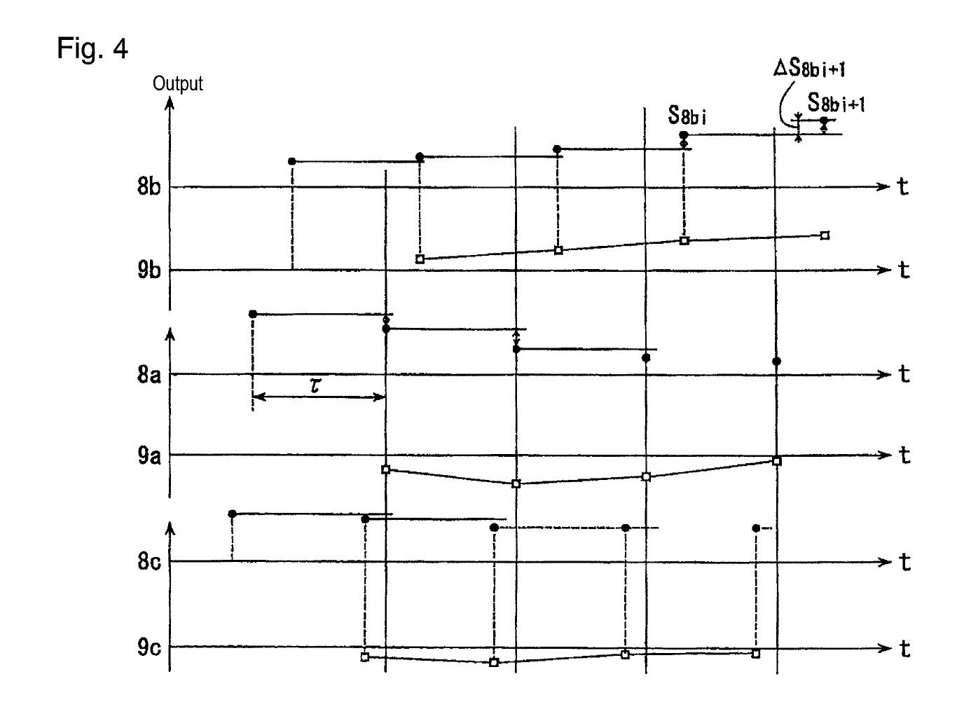

In FIG. 3, a pointer 5 moves from a position P1 to a position P2 on the board 1 in response to movement of the indicator 4. Arrows on the X-axis and the Y-axis in FIG. 3 show positive directions of the axes. FIG. 4 shows analog graphs of respective outputs of the peak detectors 8a, 8b, 8c and respective outputs of the differential detectors 9a, 9b, 9c per a time τ.

The indicator 4 outputs an ultrasonic signal per the time τ. This ultrasonic signal, upon being received by the receivers 6a, 6b, 6c, is supplied to the peak detectors 8a, 8b, 8c through the AMP/BPFs 7a, 7b, 7c, respectively. The peak detectors 8a, 8b, 8c output peak values, namely, peak voltages, every time τ. The difference detectors 9a, 9b, 9c calculate differences Δsai, Δsbi, Δsci between the peak voltages and voltages fed previously per the time τ.

The X-component detector 10b calculates, according to the equation (1), a relative moving distance of the indicator 4 in a positive or negative direction of the X-axis based on signals supplied from the difference detectors 9a, 9b.

Δxi=−Δsai·Ka1+Δsbi·Kb (1)

where, Ka1 and Kb are compensation coefficients.

The Y-component detector 10c similarly calculates, according to the equation (2), a relative moving distance of the indicator 4 in a positive or negative direction of the Y-axis based on the differences Δsai, Δsci supplied from the difference detectors 9a, 9c.

Δyi=−Δsai·Ka2+Δsci·Kc (2)

where, Ka2 and Kc are compensation coefficients.

When the indicator 4 moves rapidly, the differences Δsai, Δsbi, Δsci increase accordingly. Therefore, the relative moving distances Δxi, Δyi in the X-direction and Y-direction increase to move the pointer 5 rapidly. When the indicator 4 moves slowly, the differences Δsai, Δsbi, Δsci decrease, and therefore, the pointer 5 moves slowly.

The coordinate calculator 11 adds moving distances Δxi+1, Δyi+1 obtained by the X-component detector 10b and Y-component detector 10c to the present position of the pointer 5, for example, a reference position (X=O, Y=O) in the X-direction and Y-direction. Thereby, the calculator 11 calculates the next displayed coordinates of the pointer 5. Based on the calculated coordinates of the pointer 5, the PC 2 displays the pointer 5 on the board 1.

A user points at the board 1 with the indicator 4 from a remote place. When the user moves the indicator 4 rapidly, the differences Δsai, Δsbi, Δsci increase in response to this movement. This is reflected to the relative moving distances Δxi, Δyi in the X-direction and Y-direction to move the pointer 5 rapidly. When the user moves the indicator 4 slowly, similarly, the movement is reflected to the relative moving distances Δxi, Δyi to move the pointer 5 slowly. The user can operate the pointer displayed on the board 1 with using the indicator 4 arbitrarily, sufficiently even at a place away from the board 1.

In the embodiment 1, the receivers 6a, 6b, 6c are disposed at three places. However, receivers may be disposed at three or more places. If being not arranged in a straight line, three receivers 6a, 6b, 6c can detect horizontal and vertical components of the ultrasonic signal.

(Exemplary Embodiment 2)

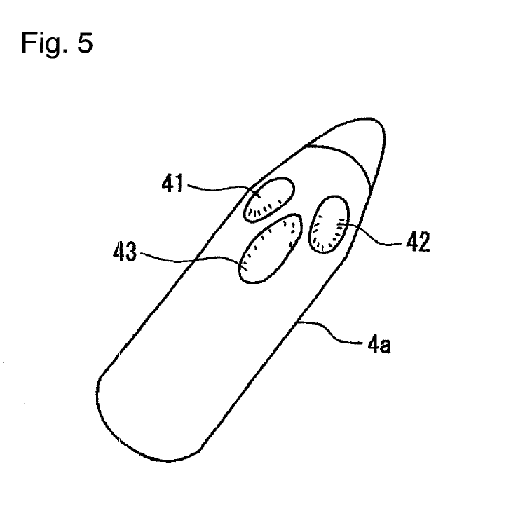

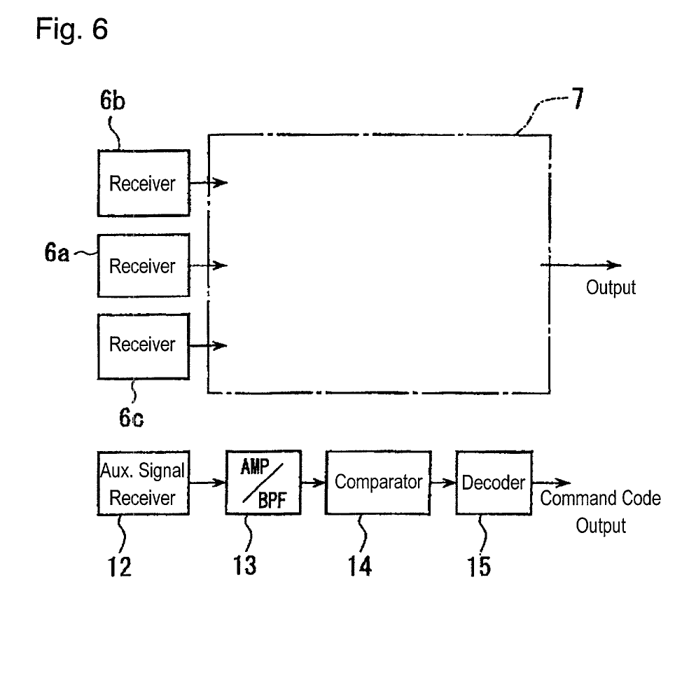

FIG. 5 is a perspective view of an indicator 4a of a pointing device in accordance with exemplary embodiment 2 of the present invention. FIG. 6 is a block diagram of a signal processing in a board employing the indicator 4a shown in FIG. 5. Elements similar to those in the embodiment 1 are denoted by the same reference numbers, and the detail descriptions of those elements are omitted.

The indicator 4a shown in FIG. 5 includes a left-button function switch 41, a right-button function switch 42, and a scroll function switch 43, as well as a function of outputting an ultrasonic signal as described in the embodiment 1. The respective switches 41, 42, 43 exhibit auxiliary functions similar to a left button, a right button, and a scroll button included in a mouse as an input device generally coupled to a personal computer (PC) 2 or the like. The indicator 4a includes an auxiliary-signal transmitter at its tip. This transmitter converts commands from the switches 41, 42, 43 to auxiliary signals of infrared radiation or radio wave, respectively, and transmits the signals.

The board 1 includes an auxiliary-signal receiver 12 shown in FIG. 6, which receives the auxiliary signals transmitted from the auxiliary-signal transmitter of the indicator 4a. The auxiliary signals received by the receiver 12 are converted to command codes through an amplifier/band-pass filter (AMP/BPF) 13, a comparator 14, and a decoder 15, and the codes are supplied to the PC 2.

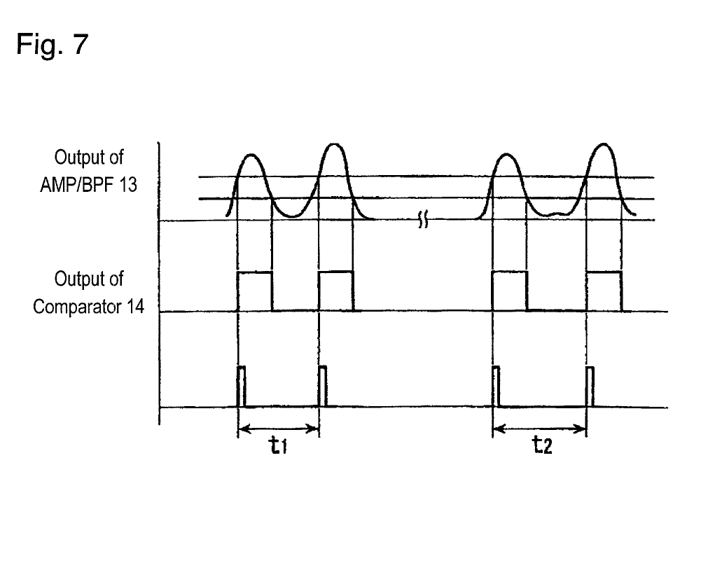

FIG. 7 shows respective outputs from the AMP/BPF 13, the comparator 14, and the decoder 15 for the auxiliary signals received by the auxiliary signal receiver 12.

A user points at the board 1 with the indicator 4a from a remote place, and pushes one of the left-button function switch 41, the right-button function switch 42, and the scroll function switch 43 on the indicator 4a. This operation is converted to auxiliary signals output at a time interval changing according to the button, and the auxiliary signals are output from the auxiliary-signal transmitter disposed at the tip of the indicator 4a. The auxiliary signals received by the auxiliary-signal receiver 12 on the board 1 are supplied through the AMP/BPF 13, and digitized by the comparator 14 as shown in FIG. 7. The decoder 15 converts output time intervals t1, t2 of the auxiliary signals to command codes, and outputs the codes to the PC 2.

The PC 2, in response to the command codes, can operate in accordance with an instruction of the auxiliary function corresponding to the left-button function switch 41, the right-button function switch 42, or the scroll function switch 43 in the indicator 4a. The user can therefore operate a pointer displayed on the board 1 with using the indicator 4a arbitrarily and sufficiently even at a place away from the board 1 as described in embodiment 1. The user can also instruct the PC 2 to operate in accordance with an auxiliary function similar to an input device such as a mouse.

The exemplary embodiments have referred to the use of ultrasonics. It is understood, however, that other forms of transmission (including, for example, RF or IR) may be used.

What is claimed is:

1. A pointing device comprising:
an indicator including a first transmitter for transmitting a first signal;
a board including at least three first receivers for receiving said first signal; and
operating means for calculating moving distances in two directions of a pointer on said board pointed by said indicator based on a varying amount of said first signal received by said first receivers.

2. A pointing device according to claim 1,
wherein said indicator further includes a second transmitter for transmitting a second signal,
wherein said board further includes:
a second receiver for receiving said second signal; and
output means for outputting a command signal in response to said second signal received by said second receiver.

3. A pointing device according to claim 2,
wherein said second transmitter transmits, as said second signal, third signals at a time interval changing in response to said command signal, and
wherein said output means outputs said command signal in response to said time interval of said third signals.
